(19) United States
(12) Patent Application Publication
(10) Pub. No.: US 2018/0356803 A1
(43) Pub. Date: Dec. 13, 2018

(54) METHOD AND SYSTEM FOR BATCH SCHEDULING UNIFORM PARALLEL MACHINES WITH DIFFERENT CAPACITIES BASED ON IMPROVED GENETIC ALGORITHM

(71) Applicant: Hefei University of Technology, Hefei (CN)

(72) Inventors: Xinbao LIU, Hefei (CN); Jun PEI, Hefei (CN); Lu JIANG, Hefei (CN); Shaojun LU, Hefei (CN); Min KONG, Hefei (CN); Xiaofei QIAN, Hefei (CN); Zhiping ZHOU, Hefei (CN); Mei XUE, Hefei (CN)

(21) Appl. No.: 16/006,743

(22) Filed: Jun. 12, 2018

(30) Foreign Application Priority Data
Jun. 12, 2017 (CN) 201710439658.6

(51) Int. Cl. G05B 19/418; G06N 3/12; G06Q 10/04; G06Q 50/04

(52) U.S. Cl. CPC G05B 19/41865; G06N 3/126; G05B 2219/32091; G06Q 50/04; G05B 2219/39167; G06Q 10/04

(57) ABSTRACT

A method and system for batch scheduling uniform parallel machines with different capacities based on an improved genetic algorithm are provided. The method is to solve the batch scheduling problem of uniform parallel machines with different capacities. Jobs are distributed to machines by an improved genetic algorithm, and a corresponding batching strategy and a batch scheduling strategy are proposed according to the natural of the problem to obtain a fitness value of a corresponding individual; then, the quality of the solution is improved by a local search strategy; and, a crossover operation is performed on a population based on the fitness of the solution, and the population is continuously updated by repetitive iteration to eventually obtain an optimal solution.

### TECHNICAL FIELD

The present invention relates to the technical field of supply chains, and in particular to a collaborative manufacturing method and system.

### BACKGROUND OF THE PRESENT INVENTION

As one of typical combinatorial optimization problems, the batch scheduling problem derives from the test stage of integrated circuit chips. The batch scheduling problem widely exists in various modern production industries, for example, the semiconductor manufacturing industry, the metal processing industry, the foundry industry or other fields. Unlike the traditional scheduling problems where one machine can process only one job, a batch processing machine can simultaneously process multiple jobs within its capacity. The rational and effective utilization of batch processing machines significantly improves the production efficiency of enterprises and increases the market competitiveness of enterprises. Therefore, studying the scheduling of batch processing machines is of great practical significance.

In previous studies, intelligent algorithms have been widely applied to solve such combinatorial optimization problems. Kashan, et al. proposed a Hybrid Genetic Algorithm (HGA) combined with heuristic algorithms to solve the problem of batch scheduling uniform parallel machines, where jobs are in different sizes. Chang, et al. proposed a simulated annealing algorithm to solve these problems. The experimental results indicate that the proposed algorithm is superior to the solving result of the CPLEX software in terms of both the solving time and the quality of the solution. Jia and Leung proposed a max-min ant colony algorithm to solve the problem of scheduling uniform parallel machines for jobs in different sizes, and the performance of this algorithm had been verified by tests. Here, the improved genetic algorithm constructed for maximizing the production benefits is based on the existing genetic algorithm. The genetic algorithm generally includes the following steps: (1) initializing a population; (2) calculating a fitness value, and recording an optimal solution; (3) performing crossover mutation; and, (4) updating and generating a next-generation population. By repeating the above steps, an optimal solution is searched from the whole space.

However, during the implementation of the embodiments of the present invention, the inventors have found that the previous papers mainly focus on the studies on the single-machine scheduling problem and the batch scheduling problem of the uniform parallel machines. Although, in recent years, there are few papers which study the parallel batch scheduling problems of different machines, these papers often focus on the difference only in a certain aspect, for example, only the difference in capacity or the difference in speed. In contrast, there are often both old and new machines in an actual production environment. Due to different equipment performance, batch processing machines on production lines have different capacities and different processing speeds. Such batch scheduling problems are more complicated and it is necessary to take the influence of the capacity and the processing speed of each machine on the optimization purpose into consideration. In addition, in terms of the used method, the genetic algorithm has the disadvantages of poor local convergence, premature convergence and the like. Particularly, for some particular optimization problems, stable and reliable solutions cannot be provided, so that it is disadvantageous for the improvement of the production efficiency in the current complicated production environment.

### SUMMARY OF THE PRESENT INVENTION

An objective of embodiments of the present invention is to solve the batch scheduling problem of uniform parallel machines with different capacities, determine a machine to which jobs are to be assigned, and determine the batching mode and batch processing sequences on this machine, so as to minimize the makespan. Based on the natural of the problem, an effective algorithm is provided to solve this combinatorial optimization problem and facilitate the improvement of the production efficiency.

In a first aspect, the embodiments of the present invention provide a method for batch scheduling uniform parallel machines with different capacities based on an improved genetic algorithm, including:

step 1: inputting the capacity of each machine and the processing time for each job, setting improved genetic algorithm parameters including the maximum number of iterations tₘₐₓ, a globally optimal solution gbest and the number of iterations t=1;

step 2: initializing a population, and defining the gene of the h^{th} chromosome among total Q chromosomes as Xₕ=(xₕ¹,xₕ², . . . ,xₕ^{d}, . . . ,xₕⁿ), h=1,2, . . . , Q, where xₕ^{d} represents the gene of the h^{th} chromosome in the d^{th} dimension and indicates that the d^{th} job is assigned to the (Xₕ^{d})^{th} machine;

step 3: generating an initial solution by a heuristic algorithm, and using the initial solution as a first chromosome in the population;

step 4: performing a local search strategy on the population to improve the quality of the population;

step 5: calculating a fitness value for each solution in the population, updating the globally optimal solution, and assigning the minimum fitness value to gbest;

step 6: randomly selecting two solutions Xₕ_{₂} and Xₕ_{₁} from the population, comparing the fitness values of the two solutions, and using the solution having a larger fineness value as a first parent solution, and repeating this operation to generate another parent solution;

step 7: setting a variable h=1; determining whether rand <0.5 is satisfied, where rand is a random number within [0,1]; if so, selecting the h^{th} gene of the first parent solution as the h^{th} gene of a filial generation; if not, selecting the h^{th} gene of the second parent solution as the h^{th} gene of the filial generation; assuming h=h+1, and repeating this step until h>n, so as to generate a new chromosome;

step 8: repeating the step 7 to generate Q filial solutions, and calculating a fitness value for each filial solution;

step 9: sequencing the original population and the filial population in a non-descending order of the fitness values; and selecting first Nₛ chromosomes in the original population and first Q-Nₛ chromosomes in the filial population to form a new population;

step 10: sequencing the new population in a non-descending order of the fitness values, and randomly generating Nₘ chromosomes to replace last Nₘ chromosomes in the new population so as to generate a next-generation population, where t=t+1; and

step 11: determining whether t≤tₘₐₓ is satisfied; if so, returning to the step 4; if not, ending the algorithm, and outputting the globally optimal solution gbest as well as the optimal processing task assignment and the batching mode and batch processing sequences on each machine.

Optionally, in the step 3, the generating an initial solution by a heuristic algorithm includes:

step 31: sequencing all jobs in a non-ascending order of the processing time to obtain a set of sequenced jobs;

step 32: sequencing all machines in a non-ascending order of the processing speed, and sequencing the machines in a non-ascending order of the capacities of the machines if the processing speed is identical;

step 33: assuming j=1, Cⱼ[i]=0, Aᵢ=0 and i=1, . . . , where Cⱼ[i] represents a completion time for a job j on a machine i, and Aᵢ represents an idle time for the machine i;

step 34: calculating

$${C}_{j} [ i ] = {A}_{i} + \frac{{p}_{j}}{{v}_{i }} , i = 1 , … , m ;$$

step 35: selecting a machine having the minimum Cⱼ[i] as a machine min, and assuming Aₘᵢₙ=Cⱼ[min] and j=j+Cₘᵢₙ;

step 36: if j<n, assigning jobs j−C_{min to j-}1 (total Cₘᵢₙ jobs) to the machine min, and executing the step 34; or otherwise, assigning all unassigned jobs in the set of jobs to the machine min, and executing a step 37; and

step 37: returning Cₘₐₓ=max_{i∈m}{Aᵢ}, and ending the algorithm.

Optionally, in the step 4, the performing a local search strategy on the population includes:

step 41: sequencing batches of the machines in a non-ascending order of the batch processing time, and sequencing jobs in the batches in a non-ascending order of the processing time;

step 42: sequencing the machines in a non-ascending order of the completion time (where the completion time for each machine is a completion time for the last batch on the machine), and assuming i=1, h=m;

step 43: selecting the i^{th} machine as a machine i, and selecting the h^{th} machine as a machine h;

step 44: if h>1, executing a step 45; or otherwise, executing a step 48;

step 45: selecting any batch b on the machine i, and selecting any batch f on the machine h;

step 46: if there is a job j in the batch f, and Pⱼ<P^{b}and P^{b}≤P^{f} are satisfied, exchanging the job j with the first job in the batch b, and executing a step 47; or otherwise, assuming h=h−1, and executing the step 44;

step 47: sequencing the jobs in the batches b and f in a non-ascending order of the processing time, and executing the step 45; and

step 48: ending the search.

Optionally, in the method, the fitness of an individual is calculated by the following steps:

step 1′: for Xₖ=(x₁,x₂, . . . ,xₕ, . . . ,xₙ) assigning the h^{th} job to the (xₕ)^{th} machine to obtain a set of jobs on each machine;

step 2′: temporarily placing the y^{th} unassigned job in the set of jobs on each machine in all batches capable of containing this job, selecting a batch having a minimum remaining batch capacity after this job is placed in the batch, and assigning this job to the selected batch; if the remaining space of all batches cannot contain the y^{th} unassigned job currently, placing this job in a new batch having a batch capacity of cᵢ, and assuming y=y+1; and

step 3′: repeating the step 2′ until all jobs in the set of jobs are assigned to corresponding batches, where the processing time for each batch is determined by the maximum processing time for the jobs in the batch.

In a second aspect, the embodiments of the present invention further provide a system for batch scheduling uniform parallel machines with different capacities based on an improved genetic algorithm, including:

a calculation module 21 used for:

step 1: inputting the capacity of each machine and the processing time for each job, setting improved genetic algorithm parameters including the maximum number

of iterations tₘₐₓ, a globally optimal solution gbest and the number of iterations t=1.

step 2: initializing a population, and defining the gene of the h^{th} chromosome among total Q chromosomes as (Xₕ=(xₕ¹,xₕ², . . . ,xₕ^{d}, . . . ,xₕⁿ), h=1,2, . . . , Q, where xₕ^{d} represents the gene of the h^{th} chromosome in the d^{th} dimension and indicates that the d^{th} job is assigned to the (xₕ^{d})^{th} machine;

step 3: generating an initial solution by a heuristic algorithm, and using the initial solution as a first chromosome in the population;

step 4: performing a local search strategy on the population to improve the quality of the population;

step 5: calculating a fitness value for each solution in the population, updating the globally optimal solution, and assigning the minimum fitness value to gbest;

step 6: randomly selecting two solutions Xₕ_{₂} and Xₕ_{₁} from the population, comparing the fitness values of the two solutions, and using the solution having a larger fineness value as a first parent solution, and repeating this operation to generate another parent solution;

step 7: setting a variable h=1; determining whether rand<0.5 is satisfied, where rand is a random number within [0,1]; if so, selecting the h^{th} gene of the first parent solution as the h^{th} gene of a filial generation; if not, selecting the h^{th} gene of the second parent solution as the h^{th} gene of the filial generation; assuming h=h+1, and repeating this step until h>n, so as to generate a new chromosome;

step 8: repeating the step 7 to generate Q filial solutions, and calculating a fitness value for each filial solution;

step 9: sequencing the original population and the filial population in a non-descending order of the fitness values; and selecting first chromosomes in the original population and first Q-Nₛ chromosomes in the filial population to form a new population; and

step 10: sequencing the new population in a non-descending order of the fitness values, and randomly generating Nₘ chromosomes to replace last Nₘ chromosomes in the new population so as to generate a next-generation population, where t=t+1; and

an output module 22 used for: step 11: determining whether t≤tₘₐₓ is satisfied; if so, returning to the step 4; if not, ending the algorithm, and outputting the globally optimal solution gbest as wen as the optimal processing task assignment and the batching mode and batch processing sequences on each machine.

Optionally, the step 3 of generating an initial solution by a heuristic algorithm executed by the calculation module 21 includes the following steps:

step 31: sequencing all jobs in a non-ascending order of the processing time to obtain a set of sequenced jobs;

step 32: sequencing all machines in a non-ascending order of the processing speed, and sequencing the machines in a non-ascending order of the capacities of the machines if the processing speed is identical;

step 33: assuming j=1, Cⱼ[i]=0, Aᵢ0 and i=1, . . . , m, where Cⱼ[i] represents a completion time for a job i on a machine j, and Aᵢ represents an idle time for the machine i;

step 34: calculating

$${C}_{j} [ i ] = {A}_{i} + \frac{{p}_{j}}{{v}_{i }} , i = 1 , … , m ;$$

step 35: selecting a machine having the minimum Cⱼ[i] as a machine min, and assuming Aₘᵢₙ=Cⱼ[min] and j=j+Cₘᵢₙ;

step 36: if j<n, assigning jobs j−Cₘᵢₙ to j−1 (total Cₘᵢₙ jobs) to the machine min, and executing the step 34; or otherwise, assigning all unassigned jobs in the set of jobs to the machine min, and executing a step 37; and

step 37: returning Cₘₐₓ=max_{i∈m} {Aᵢ}, and ending the algorithm.

Optionally, the step 4 of performing a local search strategy on the population executed by the calculation module 21 specifically includes:

step 41: sequencing batches of the machines in a non-ascending order of the batch processing time, and sequencing jobs in the batches in a non-ascending order of the processing time;

step 42: sequencing the machines in a non-ascending order of the completion time (where the completion time for each machine is a completion time for the last batch on the machine), and assuming i=1,h=m;

step 43: selecting the i^{th} machine as a machine i, and selecting the f machine as a machine h;

step 44: if h>1, executing a step 45; or otherwise, executing a step 48;

step 45: selecting any batch b on the machine i, and selecting any batch f on the machine h;

step 46: if there is a job j in the batch f, and Pⱼ<P^{b} and P^{b}≤P^{f} are satisfied, exchanging the job i with the first job in the batch b, and executing a step 47; or otherwise, assuming h=h−1, and executing the step 44;

step 47: sequencing the jobs in the batches b and f in a non-ascending order of the processing time, and executing the step 45; and

step 48: ending the search.

Optionally, the calculation module 21 is further used for calculating the fitness of an individual by the following steps:

step 1′: for Xₖ=(x₁,x₂, . . . ,xₕ, . . . ,xₙ), assigning the h^{th} job the (xₕ)^{th} machine to obtain a set of jobs on each machine;

step 2′: temporarily placing the y^{th} unassigned job in the set of jobs on each machine in all batches capable of containing this job, selecting a batch having a minimum remaining batch capacity after this job is placed in the batch, and assigning this job to the selected batch; if the remaining space of all batches cannot contain the y^{th} unassigned job currently, placing this job in a new batch having a batch capacity of cᵢ, and assuming y=y+1; and

step 3′: repeating the step 2′ until all jobs in the set of jobs are assigned to corresponding batches, where the processing time for each batch is determined by the maximum processing time for the jobs in the batch.

In the embodiments of the present invention, in view of the batch scheduling problem of uniform parallel machines with different capacities, jobs are distributed to machines by encoding by an improved genetic algorithm, and a corresponding batching strategy and a batch scheduling strategy are proposed according to the natural of the problem to obtain the fitness value of a corresponding individual; then, the quality of the solution is improved by a local search strategy; and, a crossover operation is performed on a population based on the fitness of the solution, and the population is continuously updated by repetitive iteration to eventually obtain an optimal solution. The improved genetic algorithm is a high-efficiency algorithm in terms of convergence rate and convergence effect. By this algorithm, the batch scheduling of uniform parallel machines with different capacities is realized, the production efficiency is improved, the cost is reduced, and the service level of enterprises is finally enhanced.

### BRIEF DESCRIPTION OF THE DRAWINGS

Various other advantages and benefits will become apparent to a person of ordinary skill in the art by reading the following detailed description of the preferred embodiments. The drawings are only for the purpose of illustrating the preferred embodiments, but not for the purpose of limiting the present invention. Also, identical components are denoted by identical reference numbers throughout the drawings, in which:

FIG. 1 is a schematic diagram of a batch scheduling problem of uniform parallel machines with different capacities according to one embodiment of the present invention;

FIG. 2 is a schematic flowchart of a method for batch scheduling uniform parallel machines with different capacities based on an improved genetic algorithm according to one embodiment of the present invention; and

FIG. 3 is a schematic structure diagram of a system for batch scheduling uniform parallel machines with different capacities based on an improved genetic algorithm according to one embodiment of the present invention.

### DETAILED DESCRIPTION OF THE PRESENT INVENTION

The technical solutions in the embodiments of the present invention will be clearly and completely described as below with reference to the accompanying drawings in the embodiments of the present invention. Obviously, the described embodiments are only a part of, not all of, the embodiments of the present invention. All other embodiments obtained by a person of ordinary skill in the art based on the embodiments of the present invention without paying any creative effort shall fall into the protection scope of the present invention.

Various embodiments of the present invention are mainly to solve the batch scheduling problem of uniform parallel machines with different capacities, determine a machine to which job are to be assigned, and determine the batching mode and batch processing sequences on this machine, so as to minimize the makespan. Based on the natural of the problem, an effective algorithm is provided to solve this combinatorial optimization problem and facilitate the improvement of the production efficiency.

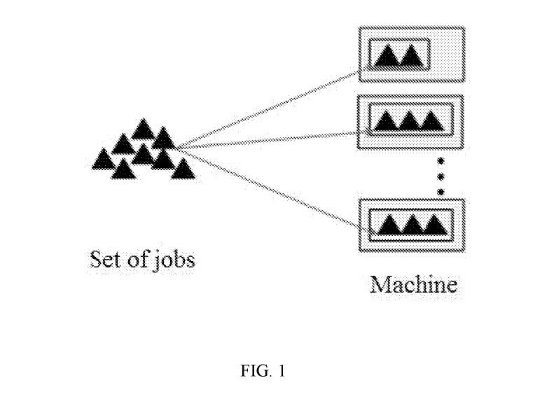

For ease of understanding, the problem to be solved by the embodiments of the present invention will be described below in detail with reference to FIG. 1.

As shown in FIG. 1, the batch scheduling problem of uniform parallel machines with different capacities is to minimize the makespan. This problem is described as follows: a set of tasks J={J₁,J₂,J₃, . . . Jₙ}) containing N jobs to be processed on m parallel batch processing machines is provided. Different jobs are different in processing time but identical in unit size. The processing time is denoted by Pⱼ(j=1,2, . . . , n). The description will be given under the following assumption:

(1) all jobs and machines get ready at moment 0, wherein the jobs are identical in unit size but different in processing time, and the batch processing machines are different in capacity and processing speed;

(2) all the jobs are compatible, a plurality of jobs can be processed in a same batch if the capacity of the machine is enough, and the time for processing the batch is determined by the job with the longest processing time in the batch and the processing machine; and

(3) the process of processing each batch is not allowed to be interrupted, and any job is not allowed to exit from or join in the process.

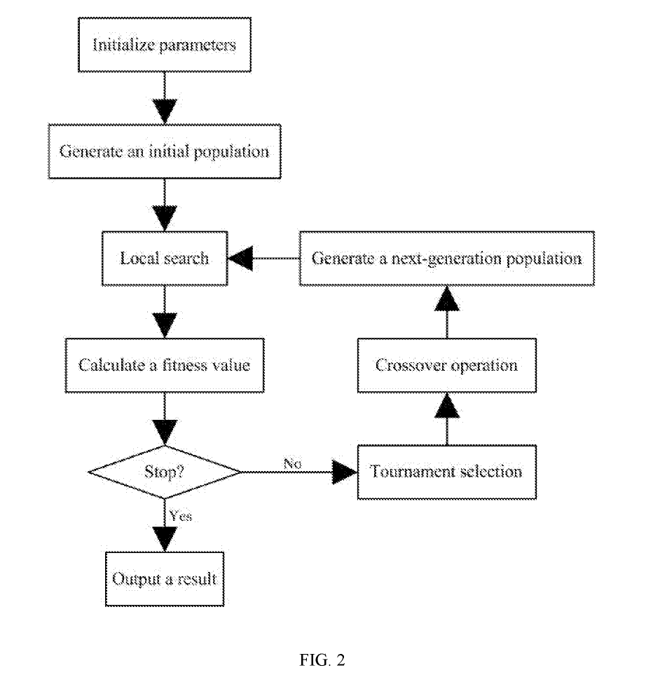

On this basis, an embodiment of the present invention provides a method for batch scheduling uniform parallel machines with different capacities based on an improved genetic algorithm, with reference to FIG. 2, including:

step 1: inputting the capacity of each machine and the processing time for each job, setting improved genetic algorithm parameters including the maximum number of iterations tₘₐₓ, a globally optimal solution gbest and the number of iterations t=1;

step 2: initializing a population, and defining the gene of the h^{th} chromosome among total Q chromosomes as Xₕ=(xₕ¹,xₕ², . . . ,xₕ^{d}, . . . ,xₕⁿ), h=1,2, . . . , Q, where xₕ^{d} represents the gene of the h^{th} chromosome in the dimension and indicates that the d^{th} job is assigned to the (xₕ^{d})^{th} machine;

step 3: generating an initial solution by a heuristic algorithm, and using the initial solution as a first chromosome in the population;

step 4: performing a local search strategy on the population to improve the quality of the population;

step 5: calculating a fitness value for each solution in the population, updating the globally optimal solution, and assigning the minimum fitness value to gbest;

step 6: randomly selecting two solutions Xₕ_{₂} and Xₕ_{₁} from the population, comparing the fitness values of the two solutions, and using the solution having a larger fineness value as a first parent solution, and repeating this operation to generate another parent solution;

step 7: setting a variable h=1; determining whether rand <0.5 is satisfied, where rand is a random number within [0,1]; if so, selecting the h^{th} gene of the first parent solution as the h^{th} gene of a filial generation; if not, selecting the h^{th} gene of the second parent solution as the h^{th} gene of the filial generation; assuming h=h+1, and repeating this step until h>n, so as to generate a new chromosome;

step 8: repeating the step 7 to generate Q filial solutions, and calculating a fitness value for each filial solution;

step 9: sequencing the original population and the filial population in a non-descending order of the fitness values; and selecting first Nₛ chromosomes in

the original population and first Q−Nₛ chromosomes in the filial population to form a new population;

step 10: sequencing the new population in a non-descending order of the fitness values, and randomly generating Nₘ chromosomes to replace last Nₘ chromosomes in the new population so as to generate a next-generation population, where t=t+1; and

step 11: determining whether t≤tₘₐₓ is satisfied; if so, returning to the step 4; if not, ending the algorithm, and outputting the globally optimal solution gbest as well as the optimal processing task assignment and the batching mode and batch processing sequences on each machine.

In a specific implementation, the generating an initial solution X_1 by a heuristic algorithm in the step 3 may be implemented in various embodiments, where an optional embodiment includes the following steps:

step 31: sequencing all jobs in a non-ascending order of the processing time to obtain a set of sequenced jobs;

step 32: sequencing all machines in a non-ascending order of the processing speed, and sequencing the machines in a non-ascending order of the capacities of the machines if the processing speed is identical;

step 33: assuming j=1, Cⱼ[i]=0, Aᵢ=0 and i=1, . . . , m, where Cⱼ[i] represents a completion time for a job j on a machine i, and Aᵢ represents an idle time for the machine i;

step 34: calculating

$${C}_{j} [ i ] = {A}_{i} + \frac{{p}_{j}}{{v}_{i }} , i = 1 , … , m ;$$

step 35: selecting a machine having the minimum Cⱼ[i] as a machine min, and assuming Aₘᵢₙ=Cⱼ[min] and j=j+Cₘᵢₙ;

step 36: if j<n, assigning jobs j−Cₘᵢₙ to j−1 (total Cₘᵢₙ jobs) to the machine min, and executing the step 34; or otherwise, assigning all unassigned jobs in the set of jobs to the machine min, and executing a step 37; and

step 37: returning Cₘₐₓ=max_{u∈m}{Aᵢ}, and ending the algorithm.

In a specific implementation, the performing a local search strategy on the population in the step 4 may be implemented in various embodiments, where an optional embodiment includes the following steps:

step 41: sequencing batches of the machines in a non-ascending order of the batch processing time, and sequencing jobs in the batches in a non-ascending order of the processing time;

step 42: sequencing the machines in a non-ascending order of the completion time (where the completion time for each machine is a completion time for the last batch on the machine), and assuming i=1, h=m;

step 43: selecting the i^{th} machine as a machine i, and selecting the h^{th} machine as a machine h;

step 44: if h>1, executing a step 45; or otherwise, executing a step 48;

step 45: selecting any batch b on the machine i, and selecting any batch f on the machine h;

step 46: if there is a job j in the batch f, and Pⱼ<P^{b} and P^{b}≤P^{f} are satisfied, exchanging the job j with the first job in the batch b, and executing a step 47; or otherwise, assuming h=h−1, and executing the step 44;

step 47: sequencing the jobs in the batches b and f in a non-ascending order of the processing time, and executing the step 45; and

step 48: ending the search.

In a specific implementation, in the method provided by the embodiment of the present invention, the fitness of an individual may be calculated by the following steps:

step 1′: for Xₖ=(x₁,x₂, . . . ,xₕ, . . . ,xₙ), assigning the h^{th} job to the (xₕ)^{th} machine to obtain a set of jobs on each machine;

step 2′: temporarily placing the y^{th} unassigned job in the set of jobs on each machine in all batches capable of containing this job, selecting a batch having a minimum remaining batch capacity after this job is placed in the batch, and assigning this job to the selected batch; if the remaining space of all batches cannot contain the y^{th} unassigned job currently, placing this job in a new batch having a batch capacity of cᵢ, and assuming y=y+1; and

step 3′: repeating the step 2′ until all jobs in the set of jobs are assigned to corresponding batches, where the processing time for each batch is determined by the maximum processing time for the jobs in the batch.

The embodiment of the present invention has the following beneficial effects.

1. In the embodiment of the present invention, in view of the batch scheduling problem of uniform parallel machines with different capacities, jobs are distributed to machines by encoding by an improved genetic algorithm, and a corresponding batching strategy and a batch scheduling strategy are proposed according to the natural of the problem to obtain a fitness value of a corresponding individual; then, the quality of the solution is improved by a local search strategy; and, a crossover operation is performed on a population based on the fitness of the solution, and the population is continuously updated by repetitive iteration to eventually obtain an optimal solution. The improved genetic algorithm is a high-efficiency algorithm in terms of convergence rate and convergence effect. By this algorithm, the batch scheduling of uniform parallel machines with different capacities is realized, the production efficiency of enterprises is improved, the cost is reduced for enterprises, and the service level of enterprises is enhanced.

2. In the embodiment of the present invention, by using a heuristic method during the generation of an initial solution, the quality of the initial population is ensured; and, by providing an effective local search strategy based on the natural of the problem, and by adjusting and improving the population after the generation of the population, the quality of parent solutions in the crossover operation is improved, the convergence capability and the convergence speed of the algorithm are improved, it is advantageous for the escape of the algorithm from the local optimization, and the diversity of the population is ensured.

3. In the embodiment of the present invention, in view of the problems of insufficient local convergence and premature convergence of the genetic algorithm, a population update strategy is provided based on the original population, cross-genes and immigrants, and both the inheritance of excellent individuals and the diversity of the population are taken into consideration. Accordingly, the problem of premature convergence of the genetic algorithm is solved, and the search efficiency of the algorithm is improved effectively.

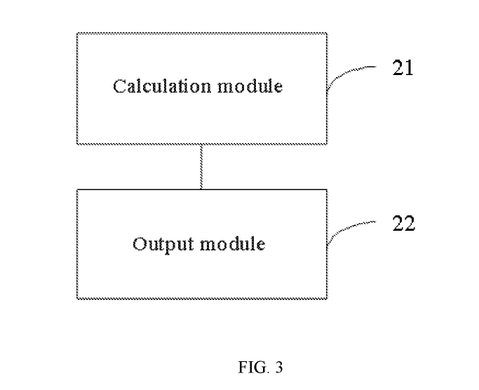

Based on the same concept, another embodiment of the present invention further provides a system for batch scheduling uniform parallel machines with different capacities based on an improved genetic algorithm, with reference to FIG. 3, including:

a calculation module 21 used for:

step 1: inputting the capacity of each machine and the processing time for each job, setting improved genetic algorithm parameters including the maximum number of iterations tₘₐₓ, a globally optimal solution gbest and the number of iterations t=1.

step 2: initializing a population, and defining the gene of the h^{th} chromosome among total Q chromosomes as Xₕ=(xₕ¹,xₕ², . . . ,xₕ^{d}, . . . ,xₕⁿ), h=1,2, . . . , Q, where xₕ^{d} represents the gene of the h^{th} chromosome in the d^{th} dimension and indicates that the d^{th} job is assigned to the (xₕ^{d})^{th} machine;

step 3: generating an initial solution by a heuristic algorithm, and using the initial solution as a first chromosome in the population;

step 4: performing a local search strategy on the population to improve the quality of the population;

step 5: calculating a fitness value for each solution in the population, updating the globally optimal solution, and assigning the minimum fitness value to gbest;

step 6: randomly selecting two solutions Xₕ_{₂} and Xₕ_{₁} from the population, comparing the fitness values of the two solutions, and using the solution having a larger fineness value as a first parent solution, and repeating this operation to generate another parent solution;

step 7: setting a variable h=1; determining whether rand <0.5 is satisfied, where rand is a random number within [0,1]; if so, selecting the h^{th} gene of the first parent solution as the h^{th} gene of a filial generation; if not, selecting the h^{th} gene of the second parent solution as the h^{th} gene of the filial generation; assuming h=h+1 and repeating this step until h>n, so as to generate a new chromosome;

step 8: repeating the step 7 to generate Q filial solutions, and calculating a fitness value for each filial solution;

step 9: sequencing the original population and the filial population in a non-descending order of the fitness values; and selecting first Nₛ chromosomes in the original population and first Q−Nₛ chromosomes in the filial population to form a new population; and

step 10: sequencing the new population in a non-descending order of the fitness values, and randomly generating Nₘ chromosomes to replace last Nₘ chromosomes in the new population so as to generate a next-generation population, where t=t+1; and

an output module used for: step 11: determining whether t≤tₘₐₓ is satisfied; if so, returning to the step 4; if not, ending the algorithm, and outputting the globally optimal solution gbest as well as the optimal processing task assignment and the batching mode and batch processing sequences on each machine.

Optionally, the step 3 of generating an initial solution by a heuristic algorithm executed by the calculation module 21 includes the following steps:

step 31: sequencing all jobs in a non-ascending order of the processing time to obtain a set of sequenced jobs;

step 32: sequencing all machines in a non-ascending order of the processing speed, and sequencing the machines in a non-ascending order of the capacities of the machines if the processing speed is identical;

assuming j=1, Cⱼ[i]=0, Aᵢ₌0 and i=1, . . . , m, where Cⱼ[i] represents a completion time for a job j on a machine i, and Aᵢ represents an idle time for the machine i;

step 34: calculating

$${C}_{j} [ i ] = {A}_{i} + \frac{{p}_{j}}{{v}_{i }} , i = 1 , … , m ;$$

step 35: selecting a machine having the minimum Cⱼ[i] as a machine min, and assuming Aₘᵢₙ=Cⱼ[min] and j=j+Cₘᵢₙ;

step 36: if j<n, assigning jobs j−Cₘᵢₙ to j−1 (total Cₘᵢₙ jobs) to the machine min, and executing the step 34; or otherwise, assigning all unassigned jobs in the set of jobs to the machine min, and executing a step 37; and

step 37: returning Cₘₐₓ=max_{i∈m}{Aᵢ}, and ending the algorithm.

Optionally, the step 4 of performing a local search strategy on the population executed by the calculation module 21 specifically includes:

step 41: sequencing batches of the machines in a non-ascending order of the batch processing time, and sequencing jobs in the batches in a non-ascending order of the processing time;

step 42: sequencing the machines in a non-ascending order of the completion time (where the completion time for each machine is a completion time for the last batch on the machine), and assuming i=1, h=m;

step 43: selecting the i^{th} machine as a machine i, and selecting the h^{th} machine as a machine h;

step 44: if h>1, executing a step 45; or otherwise, executing a step 48;

step 45: selecting any batch b on the machine i, and selecting any batch f on the machine h;

step 46: if there is a job j in the batch f, and Pⱼ<P^{b} and P^{b}≤P^{f} are satisfied, exchanging the job j with the first job in the batch b, and executing a step 47; or otherwise, assuming h=h−1 and executing the step 44;

step 47: sequencing the jobs in the batches b and f in a non-ascending order of the processing time, and executing the step 45; and

step 48: ending the search.

Optionally, the calculation module 21 is further used for calculating the fitness of an individual by the following steps:

step 1′: for Xₖ=(x₁,x₂, . . . ,xₕ, . . . ,xₙ) assigning the h^{th} job to the (xₕ)^{th} machine to obtain a set of jobs on each machine;

step 2′: temporarily placing the y^{th} unassigned job in the set of jobs on each machine in all batches capable of containing this job, selecting a batch having a minimum remaining batch capacity after this job is placed in the batch, and assigning this job to the selected batch; if the remaining space of all batches cannot contain the y^{th} unassigned job currently, placing this job in a new batch having a batch capacity of cᵢ, and assuming y=y+1; and

step 3′: repeating the step 2′ until all jobs in the set of jobs are assigned to corresponding batches, where the processing time for each batch is determined by the maximum processing time for the jobs in the batch.

With the system provided in this embodiment of the present invention, an approximately optimal solution can be obtained in view of the batch scheduling problem of uniform parallel machines with different capacities, so that the production cost is reduced for enterprises and the service level of enterprises is enhanced.

An embodiment of the present invention further discloses a computer program product which includes computer programs. The computer programs include program instructions that, when executed by a computer, enable the computer to execute the method according to the above method embodiments, for example, the method described in the first aspect.

A lot of specific details have been described in the specification provided herein. However, it can be appreciated that the embodiments of the present invention may be practiced without these specific details. In some examples, well-known methods, structures and techniques have not been shown in detail so as not to obscure the understanding to this specification.

Similarly, it should be appreciated that in the above description of exemplary embodiments of the present invention, various features of the present invention are sometimes combined together in a single embodiment, figure, or description thereof for the purpose of streamlining the disclosure and aiding in the understanding of one or more of the various inventive aspects. However, the method of the disclosure is not to be interpreted as reflecting an intention that the claimed embodiments of the invention require more features than those expressly recited in each claim. Rather, as reflected by the following claims, inventive aspects are less than all features of a single foregoing embodiment. Thus, the claims following the specific implementation mode are hereby expressly incorporated herein just as each claim itself is a separate embodiment of the present invention.

What is claimed is:

1. A method for batch scheduling uniform parallel machines with different capacities based on an improved genetic algorithm, comprising:
step 1: inputting a capacity of each machine and a processing time for a job, setting parameters of the improved genetic algorithm including the maximum number of iterations tₘₐₓ, a globally optimal solution gbest and the number of iterations t=1;
step 2: initializing a population, and defining the gene of the h^{th} chromosome among total Q chromosomes as Xₖ=(xₕ¹,xₕ², . . . ,xₕ^{d}, . . . ,xₕⁿ), h=1,2, . . . , Q, where xₕ^{d} represents the gene of the h^{th} chromosome in the d^{th} dimension and indicates that the d^{th} job is assigned to the (xₕ^{d})^{th} machine;
step 3: generating an initial solution by a heuristic algorithm, and using the initial solution as a first chromosome in the population;
step 4: performing a local search strategy on the population to improve the quality of the population;
step 5: calculating a fitness value for each solution in the population, updating the globally optimal solution, and assigning the minimum fitness value to gbest;
step 6: randomly selecting two solutions Xₕ_{₂} and Xₕ_{₁} from the population, comparing the fitness values of the two solutions, and using the solution having a larger fineness value as a first parent solution, and repeating this operation to generate another parent solution;
step 7: setting a variable h=1; determining whether rand <0.5 is satisfied, where rand is a random number within [0,1]; if so, selecting the h^{th} gene of the first parent solution as the h^{th} gene of a filial generation; if not, selecting the h^{th} gene of the second parent solution as the h^{th} gene of the filial generation; assuming h−h+1, and repeating this step until h>n, so as to generate a new chromosome;
step 8: repeating the step 7 to generate Q filial solutions, and calculating a fitness value for each filial solution;
step 9: sequencing the original population and the filial population in a non-descending order of the fitness values; and selecting first Nₛ chromosomes in the original population and first Q−Nₛ chromosomes in the filial population to form a new population;
step 10: sequencing the new population in a non-descending order of the fitness values, and randomly generating Nₘ chromosomes to replace last Nₘ chromosomes in the new population so as to generate a next-generation population, where t=t+1; and
step 11: determining whether t≤tₘₐₓ is satisfied; if so, returning to the step 4; if not, ending the algorithm, and outputting the globally optimal solution gbest as well as the optimal processing task assignment and the batching mode and batch processing sequences on each machine.

2. The method according to claim 1, wherein the step 3 further comprises:
step 31: sequencing all jobs in a non-ascending order of the processing time to obtain a set of sequenced jobs;
step 32: sequencing all machines in a non-ascending order of the processing speed, and sequencing the machines in a non-ascending order of the capacities of the machines if the processing speed is identical;
step 33: assuming j=1, Cⱼ[i]=0, and Aᵢ0 and i=1, . . . , m, where Cⱼ[i] represents a completion time for a job j on a machine i, and Aᵢ represents an idle time for the machine i;
step 34: calculating
$${C}_{j} [ i ] = {A}_{i} + \frac{{p}_{j}}{{v}_{i }} , i = 1 , … , m ,$$
where pⱼ represents a processing time for the j^{th} job, and vᵢ represents a processing speed of the i^{th} machine;
step 35: selecting a machine having the minimum Cⱼ[i] as a machine min, and assuming Aₘᵢₙ=Cⱼ[min] and j=j+Cₘᵢₙ;
step 36: if j <n, assigning jobs j−Cₘᵢₙ to j−1 to the machine min, and executing the step 34; or otherwise, assigning all unassigned jobs in the set of jobs to the machine min, and executing a step 37; and
step 37: returning Cₘₐₓ=max_{i∈m}{Aᵢ}, and ending the algorithm.

3. The method according to claim 1, wherein the step 4 further comprises:
step 41: sequencing batches of the machines in a non-ascending order of the batch processing time, and sequencing jobs in the batches in a non-ascending order of the processing time;
step 42: sequencing the machines in a non-ascending order of the completion time, and assuming i=1,h=m, where the completion time for each machine is a completion time for the last batch on the machine;
step 43: selecting the i^{th} machine as a machine i, and selecting the h^{th} machine as a machine h;
step 44: if h>1, executing a step 45; or otherwise, executing a step 48;
step 45: selecting any batch b on the machine i, and selecting any batch f on the machine h;
step 46: if there is a job j in the batch f, and Pⱼ<P^{b} and P^{b}≤P^{f} are satisfied, exchanging the job j with the first job in the batch b, and executing a step 47; or otherwise, assuming h=h−1 and executing the step 44, where P^{b} represents the processing time for the batch b;
step 47: sequencing the jobs in the batches b and f in a non-ascending order of the processing time, and executing the step 45; and
step 48: ending the search.

4. The method according to claim 1, wherein the fitness of an individual is calculated by the following steps:
step 1′: for Xₖ=(x₁,x₂, . . . ,xₕ, . . . ,xₙ), assigning the h^{th} job to the (xₕ)^{th} machine to obtain a set of jobs on each machine;
step 2′: temporarily placing the y^{th} unassigned job in the set of jobs on each machine in all batches capable of containing the y^{th} unassigned job, and then selecting a batch having a minimum remaining capacity, and assigning the y^{th} unassigned job to the selected batch; if the remaining space of all batches cannot contain the y^{th} unassigned job currently, placing the y^{th} unassigned job in a new batch having a batch capacity of cᵢ, and assuming y=y+1; and
step 3′: repeating the step 2′ until all jobs in the set of jobs are assigned to corresponding batches, where the processing time for each batch is determined by the maximum processing time for the jobs in the batch.

5. A system for batch scheduling uniform parallel machines with different capacities based on an improved genetic algorithm, comprising:
a calculation module configured to:
step 1: inputting the capacity of each machine and the processing time for each job, setting improved genetic algorithm parameters including the maximum number of iterations tₘₐₓ, a globally optimal solution gbest and the number of iterations t=1;
step 2: initializing a population, and defining the gene of the h^{th} chromosome among total Q chromosomes as Xₕ=(xₕ¹,xₕ²,. . . ,xₕ^{d},. . . ,xₕⁿ), h=1,2, . . . , Q, where xₕ^{d} represents the gene of the h^{th} chromosome in the d^{th} dimension and indicates that the d^{th} job is assigned to the (xₕ^{d})^{th} machine;
step 3: generating an initial solution by a heuristic algorithm, and using the initial solution as a first chromosome in the population;
step 4: performing a local search strategy on the population to improve the quality of the population;
step 5: calculating a fitness value for each solution in the population, updating the globally optimal solution, and assigning the minimum fitness value to gbest;
step 6: randomly selecting two solutions Xₕ_{₂} and Xₕ_{₁} from the population, comparing the fitness values of the two solutions, and using the solution having a larger fineness value as a first parent solution, and repeating this operation to generate another parent solution;
step 7: setting a variable h=1; determining whether rand <0.5 is satisfied, where rand is a random number within [0,1]; if so, selecting the h^{th} gene of the first parent solution as the h^{th} gene of a filial generation; if not, selecting the h^{th} gene of the second parent solution as the h^{th} gene of the filial generation; assuming h=h+1, and repeating this step until h>n, so as to generate a new chromosome;
step 8: repeating the step 7 to generate Q filial solutions, and calculating a fitness value for each filial solution;
step 9: sequencing the original population and the filial population in a non-descending order of the fitness values; and selecting first Nₛ chromosomes in the original population and first Q−Nₛ chromosomes in the filial population to form a new population; and
step 10: sequencing the new population in a non-descending order of the fitness values, and randomly generating Nₘ chromosomes to replace last Nₘ chromosomes in the new population so as to generate a next-generation population, where t=t+1; and
an output module configured to perform step 11: determining whether t≤tₘₐₓ is satisfied; if so, returning to the step 4; if not, ending the algorithm, and outputting the globally optimal solution gbest and the optimal processing task assignment and the batching mode and batch processing sequences on each machine.

6. The system according to claim 5, wherein the step 3 comprises:
step 31: sequencing all jobs in a non-ascending order of the processing time to obtain a set of sequenced jobs;
step 32: sequencing all machines in a non-ascending order of the processing speed, and sequencing the machines in a non-ascending order of the capacities of the machines if the processing speed is identical;
step 33: assuming j=1, Cⱼ[i]=0, Aᵢ=0 where Cⱼ[i] represents a completion time for a job j on a machine i, and represents an idle time for the machine i;
step 34: calculating
$${C}_{j} [ i ] = {A}_{i} + \frac{{p}_{j}}{{v}_{i }} , i = 1 , … , m ,$$
where pⱼ represents a processing time for the j^{th} job, and vᵢ represents a processing speed of the i^{th} machine;
step 35: selecting a machine having the minimum Cⱼ[i] as a machine min, and assuming Aₘᵢₙ=Cⱼ[min] and j=j+Cₘᵢₙ;
step 36: if j<n, assigning jobs j−Cₘᵢₙ to j−1 to the machine min, and executing the step 34; or otherwise, assigning all unassigned jobs in the set of jobs to the machine min, and executing a step 37; and
step 37: returning Cₘₐₓ=max_{i∈m}{Aᵢ}, and ending the algorithm.

7. The system according to claim 5, wherein the step 4 comprises:
step 41: sequencing batches of the machines in a non-ascending order of the batch processing time, and sequencing jobs in the batches in a non-ascending order of the processing time;
step 42: sequencing the machines in a non-ascending order of the completion time, and assuming i=1,h=m, where the completion time for each machine is a completion time for the last batch on the machine;
step 43: selecting the i^{th} machine as a machine i, and selecting the h^{th} machine as a machine h;
step 44: if h>1, executing a step 45; or otherwise, executing a step 48;
step 45: selecting any batch b on the machine i, and selecting any batch f on the machine h;
step 46: if there is a job j in the batch f, and Pⱼ<P^{b} and P^{b}≤P^{f} are satisfied, exchanging the job j with the first job in the batch b, and executing a step 47; or otherwise, assuming h=h−1, and executing the step 44, where P^{b} represents the processing time for the batch b;
step 47: sequencing the jobs in the batches b and f in a non-ascending order of the processing time, and executing the step 45; and
step 48: ending the search.

8. The system according to claim 5, wherein the calculation module is further used for calculating the fitness of an individual by the following steps:
step 1′: for Xₖ=(x₁,x₂, . . . ,xₕ, . . . ,xₙ) assigning the h^{th} job to the (xₕ)^{th}machine to obtain a set of jobs on each machine;
step 2′: temporarily placing the y^{th} unassigned job in the set of jobs on each machine in all batches capable of containing the y^{th} unassigned job, and then selecting a batch having a minimum remaining capacity, and assigning the y^{th} unassigned job to the selected batch; if the remaining space of all batches cannot contain the y^{th} unassigned job currently, placing the y^{th} unassigned job in a new batch having a batch capacity of cᵢ, and assuming y=y+1; and
step 3′: repeating the step 2′ until all jobs in the set of jobs are assigned to corresponding batches, where the processing time for each batch is determined by the maximum processing time for the jobs in the batch.
